(19) United States
(12) Patent Application Publication
(10) Pub. No.: US 2011/0076379 A1
(43) Pub. Date: Mar. 31, 2011

(54) HIGH OMEGA SATURATED FAT FREE MEAT PRODUCTS

(76) Inventor: MICHAEL M. MEANS, Topeka, KS (US)

(21) Appl. No.: 12/964,119

(22) Filed: Dec. 9, 2010

Related U.S. Application Data
(63) Continuation-in-part of application No. 12/157,855, filed on Jun. 13, 2008.

(51) Int. Cl. A23L 1/317; A23L 1/315; A23L 1/39

(52) U.S. Cl. 426/589; 426/646; 426/644

(57) ABSTRACT

A method of producing at least one of a red meat product, a pork product and a poultry product that is substantially free of unhealthy saturated fats. The method includes the steps of taking hand selected meat cuts from the at least one of red meat, pork and poultry products and grinding up the hand selected meat cuts prior to mixing such ground up meat cuts with a predetermined amount of a pre-selected oil in an amount which is at least sufficient to produce at least one of a high omega-3 and a high omega-6 low fat free product.

### CROSS REFERENCE TO RELATED APPLICATION

This application is a continuation-in-part of my co-pending patent application Ser. No. 12/157,855 filed Jun. 13, 2008, the teachings of which are incorporated herein by reference thereto.

### FIELD OF THE INVENTION

The present invention relates, in general, to various types of food products and, more particularly, the present invention relates to omega essential fatty acid (EFA) meat products, various food products and dishes containing such EFA meat products.

### BACKGROUND OF THE INVENTION

As is generally well known, prior to the conception and development of the instant invention, there has been a growing concern, among health care professionals, with individuals consuming a rather large amount of fat from many of the meat products that are presently available in today's marketplace.

There is even more of a concern that the fat being consumed contains relatively high quantities of undesirable saturated fat. Saturated fat is considered “bad” fat. The primary sources of these saturated fats are found in animal products such as red meats, pork and poultry (mostly in dark meat and skin), whole and partially skimmed dairy products and lard.

Eating too much of these saturated fats seems to be directly related to the relatively high cholesterol levels which are found in a large percentage of the world's population. Doctors are very concerned with reducing these high cholesterol levels and, in many cases, have resorted to the use of various types of medications to reduce these high cholesterol levels in their patients.

As is generally well known, particularly in the medical field, red meat has been considered one of the main culprits in producing these high cholesterol levels to the point that it is suggested that consumers eat only one or two red meat dishes a week and to not provide more than 10% of their total calorie intake from such red meat.

There is still another problem with respect to a person's health which is a different type problem. This is a problem that is directly related to a lack of omega-3 and omega-6 oils in most people's diets. It does not, however, appear to be a problem in cultures where fish seems to be a staple of the diet, or in cultures where olive oil is frequently used. This is because fish and olive oil both contain omega-3 oil.

Saturated fats have only single bonds in the carbon backbone, whereas, omega-3 is a relatively long chain mono unsaturated fatty acid and omega-6 fatty acids are also long chained, polyunsaturated fatty acids having two or more double bonds and are the building blocks of triglycerides and other lipids. These fatty acids (omega-3 and omega-6) are important because our bodies do not have the ability to create double bonds after the tenth carbon from the carboxyl group. Thus, oleic, linoleic and linolenic fatty acids are essential. However, the omega-3 seems to be much more important because the omega-6 fatty acids, although necessary, do not provide all the health benefits that are found in omega-3 fatty acids.

Thus, it would be highly advantageous if there were a meat product that would not only be low in fat content but also be substantially free of saturated fats and provide an excellent source of omega-3 and omega-6 fatty acids.

### SUMMARY OF THE INVENTION

The present invention provides a method of producing a healthy ground meat product. The method includes the steps of selecting a type of meat to be used in such product and then selecting certain cuts of the selected type of meat. Then, grinding the cuts of meat that were selected and adding a predetermined amount of a source of at least one of an omega essential fatty acid (EFA).

### OBJECTS OF THE INVENTION

It is, therefore, one of the primary objects of the present invention to provide a method of producing a healthy ground meat product containing omega essential fatty acids (EFA).

Another object of the present invention is to provide a method of producing at least one of a red meat product, a pork product and a poultry product that is substantially free of unhealthy saturated fats.

Still another object of the present invention is to provide a number of food dishes containing a substantially fat free beef, pork and poultry product having a significant amount of omega-3 oil present therein.

Yet another object of the present invention is to provide a red meat, pork and poultry product that is extra lean.

Still another object of the present invention is to provide a red meat product that is derived from cattle that have only been grass fed.

A further object of the present invention is to provide a red meat product from cattle that have never been fed any antibiotic based feed or any synthetic hormones.

An additional object of the present invention is to cross breed extra lean beef cattle with Parthenais bulls to produce an even leaner beef cattle.

Still another object of the present invention is to provide a meat product that can be mixed with a predetermined amount of a number of preselected oils which is at least sufficient to provide a product that is high in at least one of omega-3 and omega-6 fatty acids.

Yet another object of the present invention is to mix other types of meats, such as pork, turkey or chicken with olive or canola oils to produce a product that is high in omega-3 fatty acids.

It is an additional object of the present invention to provide various food dishes containing at least one of essentially fat free pork, chicken and turkey with a significant amount of at least one of omega-3, omega-6 and a combination of omega-3 and omega-6 contained therein.

In addition to the various objects and advantages of the present invention which have been described in some specific detail above it should be noted that various other objects and advantages of the present invention will become more readily apparent to those persons who are skilled in the relevant art from the following more detailed description, particularly, when such description is taken in conjunction with the appended claims.

### BRIEF DESCRIPTION OF THE PRESENTLY PREFERRED AND VARIOUS ALTERNATIVE EMBODIMENTS OF THE INVENTION

A method of producing a healthy ground meat product is provided by the present invention. The method includes the steps of first selecting a type of meat to be used in such product. Then selecting certain cuts of such meat previously selected. Thereafter, grinding up the cuts of meat selected and, then, adding a predetermined amount of a source of at least one of an omega essential fatty acid (EFA).

In the presently preferred embodiment of the invention the type of meat selected is selected from the group consisting of beef, pork and poultry. Such poultry includes both wild and domesticated poultry with such domesticated poultry being selected from the group consisting of chicken, turkey, duck and geese.

It is further presently preferred that the cuts of meats selected are those cuts that have the least amount of fat thereon. Preferably, the method includes the additional step of trimming any remaining fat and sinew from the cuts of meat selected prior to the grinding step.

Also, it is presently preferred that the omega EFA is selected from the group consisting of omega 3, omega 6 and omega 9 wherein the omega 3, omega 6 and omega 9 EFAs are selected from the group consisting of oils and ground up solids. Preferably, the oil is selected from the group consisting of canola oil, olive oil, soybean oil, cottonseed oil, sunflower oil, sesame oil, lemon oil, palm oil, coconut oil, flaxseed oil, grape seed oil, safflower oil and various combinations thereof. More, preferably, the oil is selected from the group consisting of canola oil, olive oil and combinations thereof. Most preferably, the oil is canola oil.

The method further teaches the use of ground up solids selected from the group consisting of soybeans, cottonseeds, flax seeds, grape seeds, sesame seeds, and sunflower seeds.

Additionally, the method may include the additional step of mixing a predetermined amount and a predetermined type of seasoning to the ground meat product.

When the type of meat selected is beef, the method includes the additional step of producing a product selected from the group consisting of sausage, hamburger, meatballs, deli meats, lunch meat, Salisbury steak, meat loaf, hot dogs, bratwurst, jerky, all beef bologna and beef gravy. Further, when the type of meat selected is pork and said method includes the additional step of producing a product selected from the group consisting of sausage and hot dogs. Additionally, when the type of meat selected is chicken the method includes the additional step of producing a product selected from the group consisting of nuggets, chicken fingers chicken sticks, filet patties, burgers, lunch meats, meat loaf, sausage links and patties.

As can be seen from the above description the meat product produced by this method can be used to produce a number of meat and meat containing dishes. These dishes include, but are not limited to, meatloaf, meatballs, Salisbury steak, pasta dishes, chile, fish sticks, smoked sausage, chicken burritos, chicken parmigiana, beef and bean burritos, beef and cheese burritos, beef and chicken taquitos, tacos, enchiladas, sardines and crab meats.

The present invention also provides a method for producing a substantially fat free beef and, particularly, without any significant amount of saturated fat contained therein. The method includes the steps of first selecting a breed of extra lean cattle. Thereafter, cross breeding the selected breed of extra lean beef cattle with Parthenais bulls that have only been fed grass so as to obtain an even leaner breed of cattle, which can be processed into a meat product that will be used to make numerous types of dishes.

The method includes a further step of feeding such leaner cattle derived from such cross breeding with all natural grass only and then a step of taking hand selected meat cuts from the all natural grass fed cattle. Thereafter, grinding up the hand selected meat cuts and mixing such ground up meat cuts with a predetermined amount of a preselected oil in an amount which is at least sufficient to produce at least one of a high omega-3 and a high omega-6 low fat free product.

The preselected oil is selected from the group consisting of canola oil, olive oil, soybean oil, cottonseed oil, sunflower oil, sesame oil, lemon oil and various combinations thereof. Preferably, the preselected oil is selected from the group consisting of canola oil, olive oil and a combination thereof.

The method further includes a step of preparing one of sausage, hamburger, meatloaf, hot dogs, bratwurst, jerky, all beef bologna, meatballs, Salisbury steak, pasta dishes, chile, beef and bean burritos, beef and cheese burritos, beef and chicken taquitos, tacos, enchiladas, and all beef sandwich meats from the product that was mixed with one of olive oil and canola oil.

The method further includes a step of packaging such one of sausage, hamburger, meat loaf, hot dogs, bratwurst, jerky, all beef bologna, and all beef sandwich meats from the product that was mixed with one of olive oil and canola oil.

There is also a step of mixing a predetermined amount and a predetermined type of seasoning to the product prepared in a previous step in producing one of said sausage, hamburger, meat loaf, hot dogs, bratwurst, jerky, all beef bologna, meatballs, Salisbury steak, pasta dishes, chile, beef and bean burritos, beef and cheese burritos, beef and chicken taquitos, tacos, enchiladas, and all beef sandwich meats.

The method includes a step of selecting the breed of extra lean beef cattle from at least one of Limousin, Charolais, Salair, Belgian Blue, Piedmontese and Texas Longhorn. It is presently preferred that such breed of extra lean beef selected in the first step is the breed of Limousin cattle.

It should be noted that great care is taken to ensure that the extra lean breed product prepared in a previous step is free of saturated fats. The fats that are present in the final product are essentially derived from the olive or canola oils used to mix with the ground beef. These fats are primarily mono-unsaturated fats and polyunsaturated fats which are considered “good” fats and desirable to have.

It should also be noted that although the present invention is primarily related to beef products it is within the concept of the invention that other meats such as pork, chicken or turkey can also be modified by the present invention. As is done with beef where all visual or discernable evidence of fat is stripped from the meat along with any visible sinew, the same is done with other meats.

Thus, in the case of pork where again one would take the leanest pork cuts available and then trim them so as to carefully remove all visible or discernable fat from the meat as well as removing any sign of sinew. This trimmed meat is then ground up as was done with the beef product.

The ground up lean pork is then mixed with a predetermined amount of a preselected oil in an amount which is at least sufficient to produce at least one of a high omega-3 and a high omega-6 low fat free product. The preselected oil is preferably either an olive or a canola oil. The mixed product is then formed into whatever product is desired, such as pork burgers, breakfast sausage (link and patty), summer sausage, all pork bologna, and other pork sandwich meats, all pork hot dogs, brats and polish sausages (smoked or cured). The method produces low fat pork products that are high in omega-3 and/or omega-6 fatty acids.

Similarly, chicken or turkey can also be treated as was done with pork. Most of the fat in turkey and chicken resides in the skin portion and also the dark meat portion of the bird. So, in this case one would carefully remove the skin from the turkey or chicken breast portions and also remove any visible or discernable fat (or any sinew) that might also be present. The breast portions would then be ground up and the product mixed with a predetermined amount of a preselected oil in an amount which is at least sufficient to produce at least one of a high omega-3 and a high omega-6 low fat free product. The preselected oil is preferably either an olive or a canola oil. This treated product can then be made into whatever type of product is desired. Again, this is a product that is essentially fat free with a minimum of saturated fat and a product that is high in omega-3 or omega-6 fatty acids.

As described supra where it is shown that the present invention is not only applicable to beef products but can also be used with pork or poultry it is still within the concept of the invention that such method would also be applicable to lamb or mutton or any other meat product.

As stated previously the method is primarily designed for producing essentially fat free beef products although as, again stated previously it is applicable for use with other meats.

It should be mentioned that the government regulations state that any 3 ounce serving of meat that contains less than ½ gram of fat is considered to be fat free.

To repeat the process starts with acquiring special breeds of cattle that are extra lean, such as a Limousin breed, and cross breeding that breed with Parthenais bulls that have been raised only on grass. The Parthenais bulls have never been fed synthetic hormones or given antibiotic feed of any kind.

Essentially, the only fat in the products that are prepared from meat from the cross bred cattle that have been bred for low fat content (and have been fed only grass) comes from the olive or canola oils that are added to the ground up product. Both of these oils are essentially free of saturated fats. Olive oil contains mono-unsaturated fatty acids (oleic acid) and also contain powerful antioxidants which are chemicals that fight cancer. Canola oil contains primarily mono-unsaturated fatty acids (about 55%) but also contains significant quantities of polyunsaturated fatty acids (linoleic and linolenic acids) and is also essentially free of saturated fatty acids.

The lean beef products made from red meat derived from such grass fed cattle are ground meats for making hamburgers, ground steak, breakfast sausage (link and patty), summer sausage, jerky, all beef bologna, and other beef sandwich meats, all beef hot dogs, brats and polish sausages (smoked or cured). The ground meat is so lean that it will not stick together by itself but is mixed with a predetermined amount of olive oil and/or canola oil. Both of these oils are extremely high in fats that are omega-3 based and do not contain any saturated fats.

It should be noted that the amount of oil added to ground beef varies depending upon the end use. That is, if the product is to be hamburger that is going to be fried then approximately 1½ teaspoons of oil is added to a pound of ground meat. Whereas if the hamburger is to be grilled then approximately 2¼ teaspoons of oil are added to a pound of ground beef. Similarly, if the product is to be a hot dog then between about 1¼ and 1½ teaspoons of oil are added to the ground beef. It should also be noted that sea salt is used in virtually all of the recipes in place of regular table salt. Molasses is also used instead of granulated sugar in the recipes. All of this is done to make the final product not only more tasteful but more suitable for persons who may be diabetic, have heart problems or have high cholesterol or any combination of these ailments.

The new product will allow hospitals to serve fat free foods to patients in the form of red meat without having any saturated fats in the foods. This would be very beneficial to diabetics, cancer patients, heart patients etc. Further, such products would allow restaurants and steak houses to serve low fat healthy red meat to customers that cannot eat red meat any more because of the saturated fat content. It would allow grocery stores, health food stores, deli's etc. to sell products to a large growing segment of our population who have serious health issues that have a need for products such as these that are presently not available anywhere.

This product is a saturated fat free product that is made with from extremely low fat beef that is mixed with a small percentage of a fat from olive or canola oil so as to provide the fats that are needed for a persons health.

The present invention takes hand selected and trimmed cuts of all natural, grass fed, home raised and humanely cared for “Parthenais influenced beef cattle”, that have never been fed any antibiotic based feed nor have they been given any synthetic hormones, only grass for feed. This meat is then ground and mixed with olive or canola oils to make them into the products previously mentioned. Mixing with oil is not only needed to make the product adhere to itself for forming into patties or links or any such shape but also to provide the product with essential fatty acids needed by the body. These acids are omega-3 fatty acids.

The fat free beef is mixed with the omega 3-fats (oils) to make the various saturated fat free products. The new products are used the same manner or in recipes that would normally use beef that had the animals fats therein, such as sausage, hamburgers, meat loafs, hot dogs, bratwurst, etc. There is seasoning added in the forming many of the above listed products. The seasoning would be similar to the seasoning presently used to make these products with regular fatted beef.

At present there are no other products, available on the market, that are made with red meat that have substantially zero saturated fat. The product has been approved by “Cancer Treatment Centers of America” as products that are good for diabetic and cancer patients because cancer, diabetes and clogged arteries thrive on saturated fat and this product has essentially no saturated fat present therein.

While both a presently preferred embodiment and various alternate embodiments of the present invention have been described in detail above, it should be understood that various other adaptations and/or modifications of the present invention can be made by those persons who are particularly skilled in the relevant art without departing from either the spirit of the invention or the scope of the appended claims.

I claim:

1. A method of producing a healthy ground meat product, said method comprising the steps of:
(a) selecting a type of meat to be used in such product;
(b) selecting certain cuts of said meat selected in step (a);
(c) grinding said cuts of meat selected in step (b); and
(d) adding a predetermined amount of a source of at least one of an omega essential fatty acid (EFA).

2. A method, according to claim 1, wherein said type of meat selected in step (a) is selected from the group consisting of beef, pork and poultry.

3. A method, according to claim 2, wherein said poultry includes both wild and domesticated poultry.

4. A method, according to claim 3, wherein said poultry is domesticated and is selected from the group consisting of chicken, turkey, duck and geese.

5. A method, according to claim 1, wherein said cuts of meats selected in step (b) are the cuts having the least amount of fat thereon.

6. A method, according to claim 5, wherein said method includes the additional steps of trimming any remaining fat and sinew from the from the cuts of meat selected prior to the grinding step.

7. A method, according to claim 1, wherein said omega EFA is selected from the group consisting of omega 3, omega 6 and omega 9.

8. A method, according to claim 7, wherein said omega EFA is selected from the group consisting of oils and ground up solids.

9. A method, according to claim 8, wherein said omega EFA is an oil selected from the group consisting of canola oil, olive oil, soybean oil, cottonseed oil, sunflower oil, sesame oil, lemon oil, palm oil, coconut oil, flaxseed oil, grape seed oil, safflower oil and various combinations thereof.

10. A method, according to claim 9, wherein said oil is selected from the group consisting of canola oil, olive oil and combinations thereof.

11. A method according to claim 10, wherein said oil is canola oil.

12. A method, according to claim 8, wherein said ground up solids are selected from soybeans, cottonseeds, flax seeds, grape seeds, sesame seeds, and sunflower seeds.

13. A method, according to claim 1, wherein said method further includes an additional step of mixing a predetermined amount and a predetermined type of seasoning to said ground meat product.

14. A method, according to claim 13, wherein said type of meat selected in step (a) is beef and said method includes the additional step of producing a product selected from the group consisting of sausage, hamburger, meatballs, deli meats, lunch meat, Salisbury steak, meat loaf, hot dogs, bratwurst, jerky, all beef bologna and beef gravy.

15. A method, according to claim 1, wherein said type of meat selected in step (a) is pork and said method includes the additional step of producing a product selected from the group consisting of sausage and hot dogs.

16. A method according to claim 1, wherein said type of meat selected in step (a) is chicken and said method includes the additional step of producing a product selected from the group consisting of nuggets, chicken fingers chicken sticks, filet patties, burgers, lunch meats, meat loaf, sausage links and patties.
